(19) United States
(12) Patent Application Publication
(10) Pub. No.: US 2023/0295439 A1
(43) Pub. Date: Sep. 21, 2023

(54) NAPHTHALOCYANINE AND PHTHALOCYANINE PARTICLES

(71) Applicant: BASF SE, Ludwigshafen am Rhein (DE)

(72) Inventors: Holger LEYBACH, Basel (CH); Hans REICHERT, Basel (CH); Oliver SEEGER, Ludwigshafen am Rhein (DE); Korinna DORMANN, Ludwigshafen am Rhein (DE); Helmut REICHELT, Ludwigshafen am Rhein (DE)

(21) Appl. No.: 18/011,854

(22) PCT Filed: Jun. 22, 2021
(86) PCT No.: PCT/EP2021/066906

§ 371 Date: Dec. 21, 2022

(30) Foreign Application Priority Data
Jun. 26, 2020 (EP) 20182625.2

(51) Int. Cl. C09B 47/08; C09D 11/037; C07F 5/00; B42D 25/382; B41M 3/14

(52) U.S. Cl. CPC C09B 47/08; C09D 11/037; C07F 5/003; B42D 25/382; B41M 3/14

(57) ABSTRACT

The present invention relates to particles of naphthalocyanine and phthalocyanine chromophores of formula (I) having a number average particle size in the range of from 10 nm to 80 nm with standard deviation being less than 40 nm, their use as almost colourless IR absorbers, for optical filter applications, especially for plasma display panels, or for laser welding of plastics. The compounds may be used in compositions for inks, paints and plastics, especially in a wide variety of printing systems and are particularly well-suited for security applications.

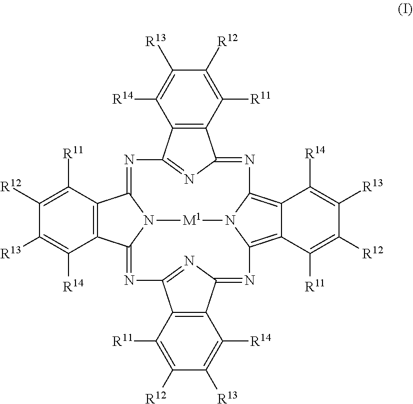

The present invention relates to particles of naphthalocyanine and phthalocyanine chromophores of formula (I) having a number average particle size in the range of from 10 nm to 80 nm with standard deviation being less than 40 nm, their use as almost colourless IR absorbers, for optical filter applications, especially for plasma display panels, or for laser welding of plastics. The compounds may be used in compositions for inks, paints and plastics, especially in a wide variety of printing systems and are particularly well-suited for security applications.

### DESCRIPTION OF THE RELATED ART

Colourless, or at least barely coloured, IR absorbers meet a significant technical need in a wide range of applications, such as security printing (bank notes, credit cards, identity cards, passports etc.), invisible and/or IR readable bar codes, the laser-welding of plastics, the curing of surface-coatings using IR radiators, the drying and curing of print, the fixing of toners on paper or plastics, optical filters for PDPs (plasma display panels), laser marking e.g. of paper or plastics, the heating of plastic preforms, heat shielding applications, etc.

A large number of organic and inorganic substances belonging to different compound classes and with a great variety of different structures are known for the application as IR absorbers. Notwithstanding that large numbers of known compound classes and structures with a complex profile of properties often presents difficulties, there is a continuing demand for IR absorbers that are “colourless” (i.e. with the minimum possible inherent colour), and that simultaneously meet the technical stability requirements (chemical stability, heat stability and/or light stability).

A special field of application for colourless IR absorbers regards inks for printing processes which are used for printing currency and other security documents, also referred to as “security printing”. Typical security printing processes are processes, wherein an ink composition is employed that is designed to selectively absorb radiation in parts of the “optical infrared” spectrum, whilst being transparent in other parts of it. IR absorbers for security printing are available, for example, from “American Dye Source”, but virtually all of them have a noticeable absorption in the visible (VIS) range of the spectrum (from 400 to 700 nm).

WO2006/015414 describes IR-absorbing naphthalocyanine compounds for security printing. These compounds may have different axial substituents and a variety of central atoms.

WO2006/015414 describes IR-absorbing naphthalocyanine compounds.

WO2008/006136 (US2009043108) discloses a specific Ga naphthalocyanine compound with an ethylenoxide derived axial substituent. These types of substituents render the compounds more watersoluble.

WO2009/012514 discloses a further specific Ga naphthalocyanine compound with a C₁₆alkyl axial substituent which may impart more oil solubility to the compound.

WO2009/100239 discloses the synthesis of the following phthalocyanine compounds:

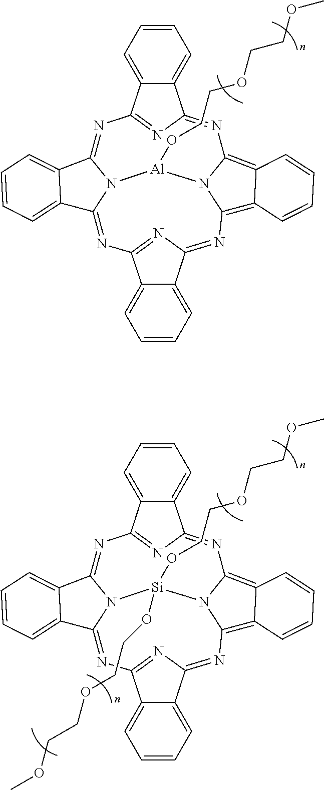

EP0628607 relates to naphthalocyanines of the general formula

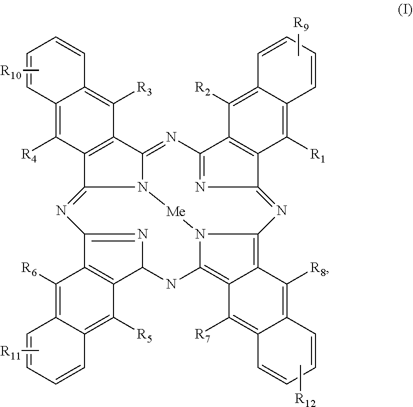

wherein
R¹, R², R³, R⁴, R⁵, R⁶, R⁷ and R⁸ are each independently of the others hydrogen, hydroxyl or C₁-C₂₀-alkyl or C₁-C₂₀-alkoxy, whose carbon chains may each be interrupted by from 1 to 4 oxygen atoms in ether function and which may be phenyl-substituted, R⁹, R¹⁰, R¹¹ and R¹² are each independently of the others hydrogen, halogen or C₁-C₂₀-alkyl or C₁-C₂₀-alkoxy, whose carbon chains may each be interrupted by from 1 to 4 oxygen atoms in ether function,
Me is two hydrogen atoms, two univalent metal atoms or a bivalent metal atom with or without further substituents for valence saturation,
as pigments with isometric particles and a particle size distribution from 10 to 300 nm.

The naphthalocyanines are obtainable by
a) dry grinding the as-synthesized crude product and if desired
b) then treating the ground product at elevated temperature with a liquid consisting essentially of water and an organic solvent or
c) wet grinding the as-synthesized crude product in a liquid consisting essentially of water and an organic solvent, with or without
d) a subsequent heat treatment of the suspension obtained in c).

JP2002309131 discloses a near-infrared-ray-absorbing ink is characterized in that at least one naphthalocyanine pigment is ground to an average particle size of 0.5 microns or less and dispersed in an ink medium.

US20060030638 A1 relates to a method of minimizing absorption of visible light in an ink composition comprising an IR-absorbing metal cyanine dye, said method comprising preselecting said dye such that said metal has at least one axial ligand bound thereto, wherein said axial ligand comprises a moiety suitable for reducing intermolecular interactions between adjacent dye molecules.

US20090227785A1 relates to a process for preparing nanoscale pigment particles of phthalocyanine pigments, comprising:
providing a unsubstituted phthalocyanine chromogen material and a substituted phthalocyanine chromogen material,
reacting the unsubstituted phthalocyanine chromogen material and the substituted phthalocyanine chromogen material to form a mixture of unsubstituted phthalocyanine dye molecules and substituted phthalocyanine dye molecules, and
causing said substituted phthalocyanine dye molecules to non-covalently associate with the unsubstituted phthalocyanine dye molecules, so as to limit an extent of particle growth and aggregation and result in nanoscale pigment particles. The terms “nanosized,” “nanoscale,” or “nanometer-sized pigment particles” refers to for instance, an average particle size, d50, or an average particle diameter of less than about 150 nm, such as of about 1 nm to about 100 nm, or about 10 nm to about 80 nm.

The nanoscale pigment particles are preferably formed without utilizing a grinding step to reduce a particle size of formed crystal particles.

WO2015/169701 relates to Ga-naphthalocyanine chromophores of formula

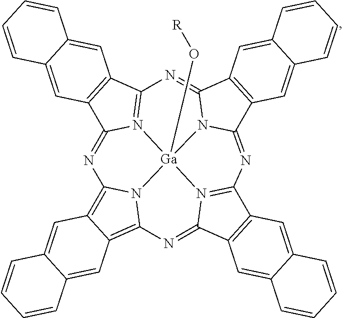

wherein R is C₁-C₆alkyl, their use as almost colourless IR absorbers, for optical filter applications, especially for plasma display panels, or for laser welding of plastics.

EP2483355A1 relates to a pigment dispersion comprising:
milled particles of naphthalocyanine pigment having particle size in the range of 10 nm to 160 nm;
an anionic surfactant of asymmetric structure as dispersant for the naphthalocyanine pigment; and water,
wherein the naphthalocyanine pigment is a near infrared (NIR) absorbing compound that absorbs light in the wavelength range of about 700 nm to 1400 nm, and
wherein the anionic surfactant has (i) a flexible part, which comprises an alkyl chain, or alkyl chain connected to poly(ethylene oxide) (PEO) chain, and (ii) at least one hydrophilic, anionic head group directly attached to the alkyl chain or PEO chain.

The dispersion is produced by introducing raw naphthalocyanine pigment with particle size greater than 200 nm, an anionic surfactant of asymmetric structure and water into a bead mill which contains beads having diameter of less than 1.0 mm as the grinding medium; and milling to produce a dispersion containing pigment particles having particle size in the range of 10 nm to 160 nm.

WO2016/193237 relates to the use of naphthalocyanine chromophores of formula

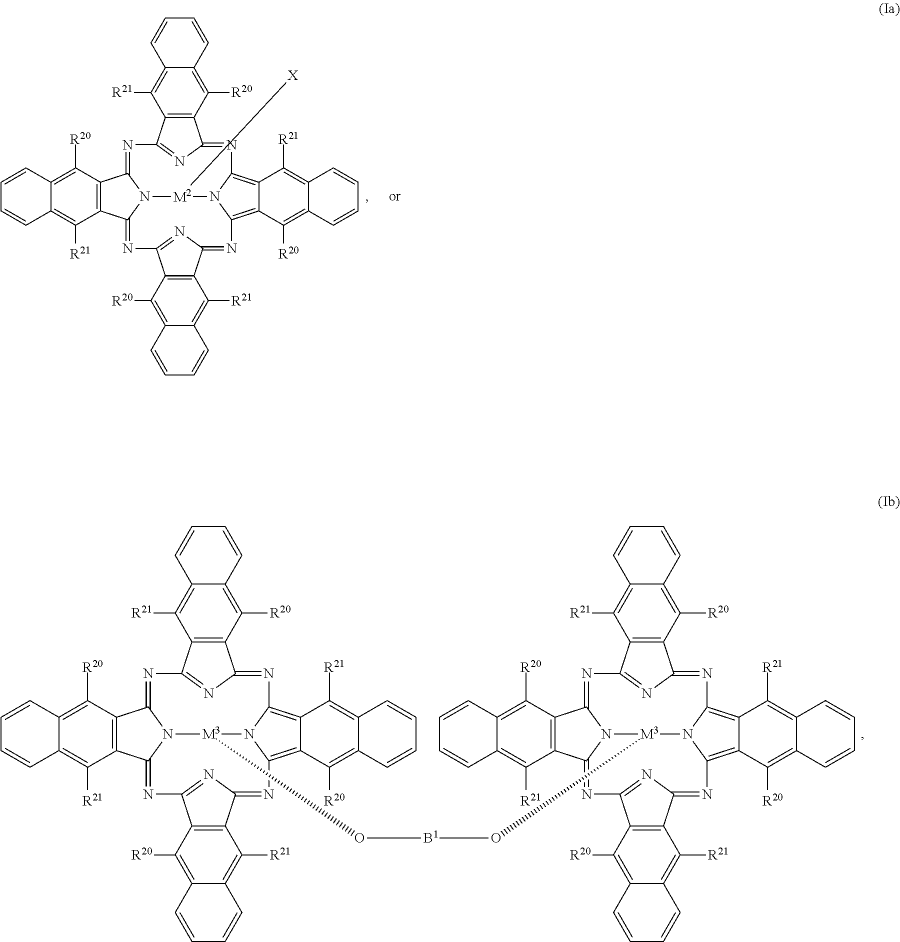

wherein
X is OH, O(C₂H₄O)ₙCH₃, OC₈-C₁₈alkyl, OSi(n-C₁-C₁₂alkyl)₃;
n is an integer from 1 to 6;
M², M³ are Ga;
B¹ in formula (Ib) is C₁-C₁₂alkylene, C₁-C₁₂alkylene which is interrupted by one or more oxygen atoms or C₁-C₁₂alkylene which is substituted by at least one OH group;
R²⁰ and R²¹ are independently of each other H, F, OR¹⁶, SR¹⁶, NHR¹⁷, or NR¹⁷R^{17′};
R¹⁶ is C₁-C₁₂alkyl, (C₂H₄O)ₙOR¹⁸, or phenyl;
R¹⁸ is C₁-C₁₂alkyl;
R¹⁷ and R^{17′} are independently of each other C₁-C₁₂alkyl, (C₂H₄O)ₙOR¹⁸, or phenyl; or
R¹⁷ and R^{17′} together may represent a 5- or 6-membered aliphatic ring, wherein one C-atom in the ring may be replaced by oxygen, to form a pyrrolidine, piperidine, 2-methylpiperidine or morpholine radical; as almost colourless IR absorbers for security printing applications

WO2020/165099 relates to compounds of formula

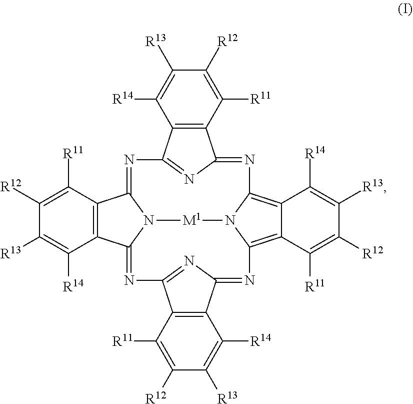

wherein
M¹ is Al(R¹⁵), or Ga(R¹⁵)
R¹⁵ is OR¹⁶;
R¹¹ and R¹⁴ are independently of each other H, F, OR^{17″}, SR^{17′}, or NR¹⁷R^{17′},
R¹² and R¹³ are independently of each other H, F, OR^{17″}, SR^{17″}, NHR¹⁷, or NR¹⁷R^{17′}, or
R¹² and R¹³ together with the C atoms to which they are bonded form a 6-membered aromatic ring, which may optionally be substituted;
R¹⁶ is a group of formula

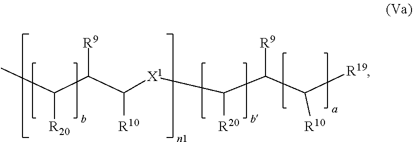

especially (CH₂CH₂O)ₙ₁CH₂CH₂R¹⁹, (CH₂CH(CH₃)O)ₙ₁CH₂CH(CH₃)R¹⁹, (CH₂CH₂CH₂O)ₙ₂CH₂CH₂CH₂R¹⁹, or (CH₂CH₂NH)ₙ₃CH₂CH₂R¹⁹;

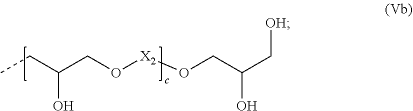

especially

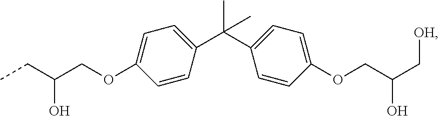

or CH₂CH(OH)CH₂OH; or

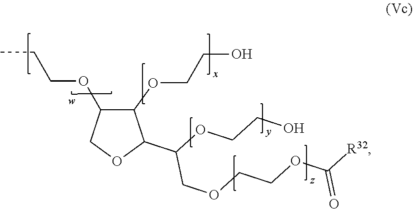

especially a group of formula (Vc), wherein w+x+y+z=20 and R³² is (CH₂)₁₀CH₃, (CH₂)₁₂CH₃, (CH₂)₁₄CH₃ and (CH₂)₁₆CH₃;
X¹ is O, S or NH,
X² is

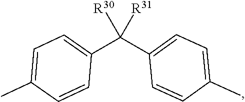

w+x+y+z=4 to 20;
R⁹ and R¹⁰ are the same or different and are each independently hydrogen, or a methyl group;
R¹⁷, R^{17′} and R^{17″} are independently of each other a C₁-C₁₂alkyl group, (CH₂CH₂O)ₙOR¹⁸, or phenyl; or
R¹⁷ and R^{17′} together with the C atoms to which they are bonded form a saturated 5- or 6-membered N-heterocyclic ring, which is optionally substituted by 1 or 2 methyl groups;
R¹⁸ is a C₁-C₁₂alkyl group;
R¹⁹ is OH, or NH₂;
R²⁰ is H, or a C₁-C₄alkyl group;
R³⁰ and R³¹ are independently of each other hydrogen, or a C₁-C₄alkyl group; or
R³⁰ and R³¹ form a five, or six-membered ring, which may optionally be substituted,
R³² is a C₁-C₂₅alkyl group, or a C₂-C₂₅alkenyl group,
a is 0, or 1; b is 0, or 1; b′ is 0, or 1; c is 1;
n is 0, 1, 2, 3 or 4; and
n1 is 0, or a value from 1 to 10; n2 is 0, or a value from 1 to 10; n3 is a value from 1 to 10.

### DESCRIPTION OF THE INVENTION

The objective of the instant invention is to provide Ga/Al (na)phthalocyanine compounds with absorbing properties, light stability and heat stability as high as possible. In the area of pigments proper particle size, shape and particle size distribution have an impact on the so-called secondary properties like light-, heat- and chemical fast nesses. This is achieved by pigment finishing with physical methods. Without proper ripening, narrow and uniform particle size distribution can't be achieved in a kneading procedure.

The problem has been solved by providing the particles of the compounds of formula (I) having a number average particle size in the range of from 10 nm to 80 nm with standard deviation being less than 40 nm. The compounds exhibit high absorbing properties, thermal and light fastness, high resistance against chemicals and solvents with out losing their other advantages like colourlessness. They can be advantageously employed as IR absorbers for security printing and the laser-welding of plastics. Due to their unique application properties they are in particular suitable as IR absorbers for security printing, especially for bank notes.

In a first aspect, the invention relates to particles of a compound of formula

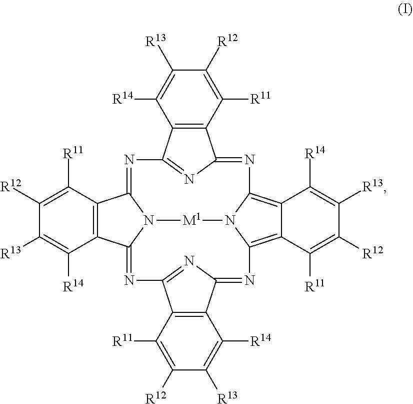

wherein
M¹ is Al(R¹⁵), or Ga(R¹⁵),
R¹⁵ is OH, or OR¹⁶, especially OR¹⁶;
R¹¹ and R¹⁴ are independently of each other H, F, OR^{17″}, SR^{17″}, or NR¹⁷R^{17′},
R¹² and R¹³ are independently of each other H, F, OR^{17″}, SR^{17″}, NHR¹⁷, or NR¹⁷R^{17′}, or
R¹² and R¹³ together with the C atoms to which they are bonded form a 6-membered aromatic ring, which may optionally be substituted,
R¹⁶ is a group of formula

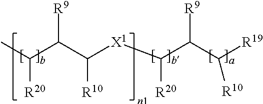

(Va), especially (CH₂CH₂O)ₙ₁CH₂CH₂R¹⁹, (CH₂CH(CH₃)O)ₙ₁CH₂CH(CH₃)R¹⁹, (CH₂CH₂CH₂O)ₙ₂CH₂CH₂CH₂R¹⁹, or (CH₂CH₂NH)ₙ₃CH₂CH₂R¹⁹;
X¹ is O, S or NH,
R⁹ and R¹⁰ are the same or different and are each independently hydrogen, or a methyl group;
R¹⁷, R^{17′} and R^{17″} are independently of each other a C₁-C₁₂alkyl group, (CH₂CH₂O)ₙR¹⁸, or phenyl; or
R¹⁷ and R^{17′} together with the C atoms to which they are bonded form together a 5- or 6-membered saturated N-heterocyclic ring, which is optionally substituted by 1 or 2 methyl groups;
R¹⁸ is a C₁-C₁₂alkyl group;
R¹⁹ is a OC₁-C₁₂alkyl group, especially a OC₁-C₄alkyl group;
R²⁰ is H, or a C₁-C₄alkyl group;
a is 0, or 1; b is 0, or 1; b′ is 0, or 1;
n is 0, 1, 2, 3 or 4; and
n1 is 0, or a value from 1 to 10; n2 is 0, or a value from 1 to 10; n3 is a value from 1 to 10; wherein the particles have a number average particle size in the range of from 10 nm to 80 nm, preferably from 20 nm to 70 nm, more preferably 30 to 60 nm with standard deviation being less than 40 nm, especially less than 30 nm, very especially less than 25 nm.

In a preferred embodiment the particles of the compound of formula (I), especially of formula (Ia) and (Ib), have a number average particle size in the range of from 30 to 60 nm with standard deviation being less than 40 nm, especially less than 30 nm, very especially less than 25 nm.

In a preferred embodiment 90% of the particles of the compound of formula (I), especially of formula (Ia) and (Ib), have diameters below 90 nm, especially below 80 nm, very especially below 70 nm (D₉₀).

In a particularly preferred embodiment the present invention is directed to particles of the compound of formula (I), especially of formula (Ia) and (Ib), very especially compound 1c, having a number average particle size in the range of from 30 to 60 nm with standard deviation being less than 25 nm and a D₉₀ below 70 nm.

The wording that the “number average particle size in the range of from X to Y nm (or is from X to Y nm)” means: X nm≤number average particle size≤Y nm.

The particles of the compounds of formula (I) may be used as colourless IR absorber, for optical filter applications, especially for plasma display panels, laser marking, or for laser welding of plastics.

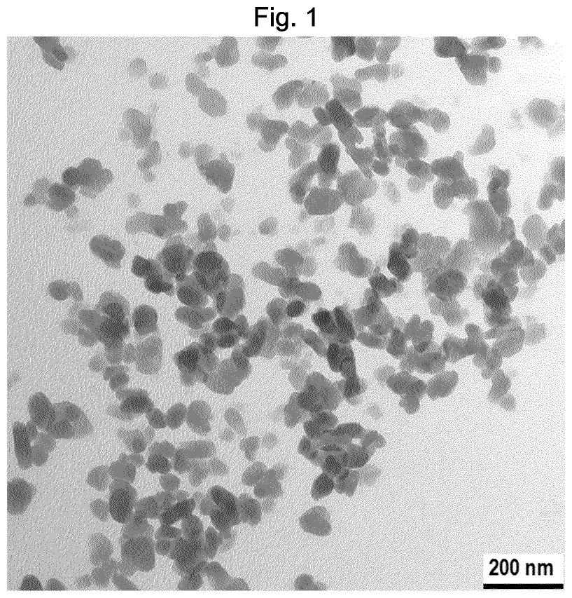

FIG. 1 is a Transmission Electron Micrograph (TEM) of the particles of the compound (1c), obtained in Example 1.

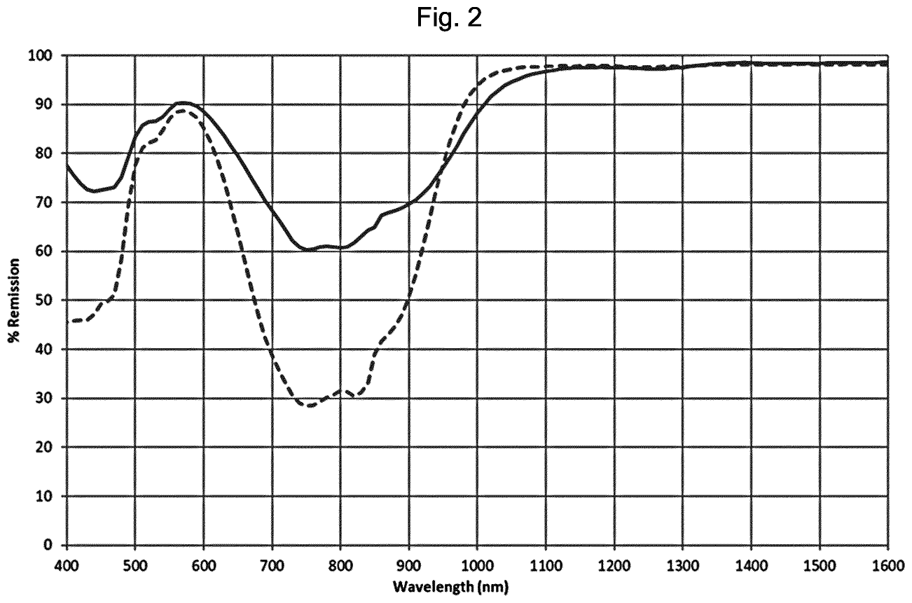

FIG. 2. Remission spectra of cpd. 1c (inventive; [symbol] ) and cpd. CC-1 (comparative; [symbol] obtained according to Example 1a.

The number average particle size is the number weighted mean diameter (Feret diameter). The median particle size (D₅₀) is the value separating the higher half of the data from the lower half. It is the determined particle size from which half of the particles are smaller and half are larger. D₉₀: The portion of particles with diameters below this value is 90%.

In a preferred embodiment R¹² and R¹³ in formula (I) (and (Ia) are independently of each other H, OR^{17″}, or NHR¹⁷, in particular H, or OR^{17″}. In said embodiment R¹² and R¹³ have preferably the same meaning.

In another preferred embodiment R¹² and R¹³ together with the C atoms to which they are bonded form a 6-membered aromatic ring, which may optionally be substituted, such as

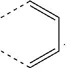

The compound of formula (I) is preferably a compound of formula

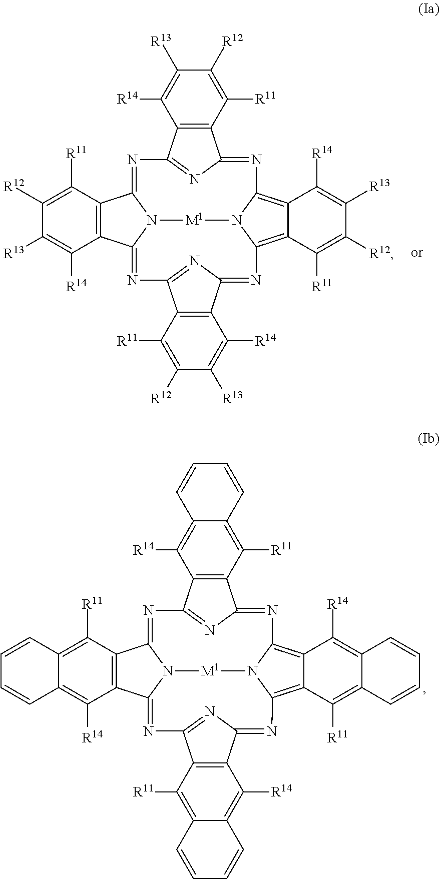

wherein R¹² and R¹³ are independently of each other H, F, OR^{17″}, SR^{17″}, NHR¹⁷, or NR¹⁷R¹⁷, and M₁, R¹¹, R¹⁴, R¹⁷, R^{17′} and R^{17″} are defined above, or below.

Preferably, the radicals R¹¹ and R¹⁴ in formula (I) are independently of each other H, OR^{17″}, or NHR¹⁷, in particular H, or OR^{17′}.

According to a preferred embodiment of the invention the radicals R¹¹ and R¹⁴ have the same meaning.

The groups R¹⁷, R^{17′}, R^{17″} and n have the following preferred meanings:
R^{17″} is C₁-C₁₂₁alkyl, or (C₂H₄O)ₙR¹⁸, in particular (C₂H₄O)ₙR¹⁸;
R¹⁷ and R^{17′} are independently of each other C₁-C₁₂alkyl, or (C₂H₄O)ₙR¹⁸, more preferably C₁-C₆alkyl, or (C₂H₄O)ₙR¹⁸, or R¹⁷ and R^{17′} together form a 5- or 6-membered saturated N-heterocyclic ring, such as, for example, a pyrrolidine, a piperidine, a 2-methylpiperidine, or a morpholine ring;
R¹⁸ is C₁-C₁₂alkyl, in particular C₁-C₄alkyl;
n is 1, 2 or 3, in particular 2 or 3.

In the compound of formula (Ib) R¹¹ and R¹⁴ are preferably H.

In the compound of formula (Ia) R¹¹, R¹², R¹³ and R¹⁴ are H.

M¹ is preferably Ga(R¹⁵) R¹⁵ is preferably OR¹⁶.

In a preferred embodiment R¹⁶ is a group of formula

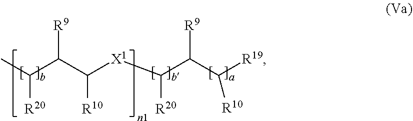

wherein
X¹ is O, S or NH;
R²⁰ is hydrogen, or a C₁-C₄alkyl group;
R⁹ and R¹⁰ are the same or different and are each independently hydrogen, or a methyl group;
R¹⁹ is a OC₁-C₁₂alkyl group, especially a OC₁-C₄alkyl group;
a is 0, or 1; b is 0, or 1; b′ is 0, or 1; and n1 is 0, or a value from 1 to 10.

It should be noted that, for example, units with identical or different R⁹; R¹⁰ and R²⁰ groups occur, in which case units with different substitution, i.e. propylene oxide- and/or ethylene oxide-based, are present in any sequence and repetition in the particular group.

In said embodiment groups of formula (CH₂CH₂O)ₙ₁CH₂CH₂R¹⁹, (CH₂CH(CH₃)O)ₙ₁CH₂CH(CH₃)R¹⁹, (CH₂CH₂CH₂O)ₙ₂CH₂CH₂CH₂R¹⁹ and (CH₂CH₂NH)ₙ₃CH₂CH₂R¹⁹ are preferred and groups of formula (CH₂CH₂O)ₙ₁CH₂CH₂R¹⁹ and (CH₂CH(CH₃)O)ₙ₁CH₂CH(CH₃)R¹⁹ are most preferred.
n1 is 0, or a value from 1 to 10; especially 1 to 4.
n2 is 0, or a value from 1 to 10; especially 1 to 4.
n3 is a value from 1 to 10, especially 1 to 4.

R²⁰ is preferably H. R¹⁹ is preferably a OC₁-C₄alkyl group.

Examples of compounds of formula (I) are compounds 1a to 1j, 2a to 2j, 3a to 3j and 4a to 4j listed in claim 5, wherein compounds 1a to 1f are preferred.

The process for the production of the particles according to the present invention comprises
a) providing a mixture of a compound of formula (I), a solvent and an inorganic salt; and
b) kneading the mixture at a temperature of from 20 to 150° C. for a sufficient period of time.

In general, the kneading mass contains, per g of the total mass of the compound of formula (I) from 1 to 15 g, preferably from 2 to 8 g of inorganic salt and from 0.3 to 2 g, preferably from 0.5 to 2 g of a solvent, or a compound of formula HOR¹⁶ (III).

The solvent is preferably selected from a protic solvent, an aprotic solvent, such as, for example, N,N-dimethylformamide (DMF) and N-Methyl-2-pyrrolidone (NMP); a polyol, such as, for example, a glycol, or glycerol; a compound of formula HOR¹⁶ (III) and mixtures thereof. The groups R¹⁶ in the compound of formula (I) and (III) have preferably the same meaning.

Suitable salts for salt kneading are water-soluble salts having a solubility of at least 10 g/100 ml in water. Suitable examples are sodium chloride, potassium chloride, calcium chloride, zinc chloride, aluminum chloride, sodium sulfate, aluminum sulfate and calcium carbonate, with or without water of crystallization. Preferred inorganic salts are sodium chloride and sodium sulfate, more preferably sodium chloride. Typically, technical-grade salts with or without preceding micronization are used. The salts preferably have an average particle size of from 5 to 200 μm, more preferably from 10 to 50 μm.

The kneading temperature is generally of from 20 to 150° C., preferably 30 to 110° C. The salt kneading step should be carried out for a sufficient period of time to allow the particles to attain optimum stability, pigmentary size and distribution. The period of time is not critical and may range from 2 to 15 hours, preferably 2 to 10 hours, in particular from 2 to 6 hours.

The speed or rotation rate is appropriately selected in such a way that the kneading mass is moved homogeneously and with uniform shear. The product resulting after kneading may be stirred and granulated in water to remove salt and organic liquid and isolated by common methods, like filtering, washing usually salt free with water and drying, preferably at a temperature of from 50 to 90° C.

Any kneader for salt kneading known in the art may be used, for example, common double-shaft kneaders, such as Z-blade kneaders, planetary kneaders or screw kneaders, but also single-shaft kneaders, high speed mixers or extruders are likewise possible.

The particles of the compounds of formula (I), especially of formula (Ia) and (Ib), have a number average particle size in the range of from 10 nm to 80 nm, preferably from 20 nm to 70 nm, more preferably 30 to 60 nm with standard deviation being less than 50 nm, especially less than 30 nm, very especially less than 25 nm. The particle size is measured with transmission electron microscopy (TEM).

In a preferred embodiment the particles of the compound of formula (I), especially of formula (Ia) and (Ib), have a number average particle size in the range of from 30 to 60 nm with standard deviation being less than 40 nm, especially less than 30 nm, very especially less than 25 nm.

In a preferred embodiment 90% of the particles of the compound of formula (I), especially of formula (Ia) and (Ib), have diameters below 90 nm, especially below 80 nm, very especially below 70 nm (D₉₀).

In a particularly preferred embodiment the present invention is directed to particles of the compound of formula (I), especially of formula (Ia) and (Ib), very especially compound 1c, having a number average particle size in the range of from 30 to 60 nm with standard deviation being less than 25 nm and a D₉₀ below 70 nm.

TEM analysis of dispersions was performed on “Libra 120”, an instrument from ZEISS in bright field mode at an electron beam acceleration voltage of 120 kV. The TEM was used with an energy filter for better contrast. At least 2 representative images with scale in the same magnification were recorded in order to characterize the dominate particle morphology for each sample. The minimal feret diameter of the particles was determined with the software “ImageJ”, which is based on the measurement of at least 4800 randomly selected particles.

The term “alkyl” relates to a linear or branched, saturated hydrocarbon radical having usually 1 to 25 carbon atoms, in particular 1 to 12 carbon atoms, frequently, 1 to 6 car bon atoms, in particular 1 to 4 carbon atoms, such as methyl, ethyl, n-propyl, isopropyl, n-butyl, 2-butyl, isobutyl, tert.-butyl, n-pentyl, 2-pentyl, 1,2-dimethylpropyl, 2,2-dimethylpropyl, n-hexyl, 2-hexyl, 2,3-dimethylbutyl, n-heptyl, 2-heptyl, n-octyl, 2 octyl, 2-ethylhexyl, 2,4,4-trimethylpentyl, n-nonyl, 2-nonyl, n-decyl, 2-decyl, n undecyl, 2-undecyl, n-dodecyl, 2-dodecyl and 2,4,4,6,6-pentamethyldecyl.

The laser welding is preferably carried out using a YAG laser or using a diode laser emitting within the absorption range of the aforementioned IR absorber of the formula (I). The concentration of the IR absorber of the formula (I) or of IR absorber mixtures is e.g. from 5 to 500 ppm, preferably from 10 to 200 ppm.

In laser welding, plastics components are welded to one another. The plastics components to be fused may have any shape. For example, at least one of the plastics components may be a film.

The particles of the compounds of formula (I) according to the invention are suitable for welding NIR transparent at least translucent plastic materials. The employed plastic materials may be colourless or coloured. In principle, the plastic components to be fused may be composed of the same polymer or of different polymers. Preferably, the plastic components employed for laser welding are selected from thermoplastic polymers. However, it is also possible that neither of the plastic components to be fused is composed of thermoplastic; however, a coating of at least one part with a thermoplastic comprising the particles of the compound of the formula (I) is required.

The plastic components employed for laser welding preferably comprise or consist of at least one polymer selected from polyolefins, polyolefin copolymers, polytetrafluoroethylenes, ethylene-tetrafluoroethylene copolymers, polyvinyl chlorides, polyvinylidene chlorides, polyvinyl alcohols, polyvinyl esters, polyvinyl alkanals, polyvinyl ketals, polyamides, polyimides, polycarbonates, polycarbonate blends, polyesters, polyester blends, poly(meth)acrylates, poly(meth)acrylate-styrene copolymer blends, poly(meth)acrylate-polyvinylidene difluoride blends, polyurethanes, polystyrenes, styrene copolymers, polyethers, polyether ketones and polysulfones and mixtures thereof.

Preference is given to matrix polymers from the group of the polyolefins, polyolefin co polymers, polyvinyl alkanals, polyamides, polycarbonates, polycarbonate-polyester blends, polycarbonate-styrene copolymer blends, polyesters, polyester blends, poly(meth)acrylates, poly(meth)acrylate-styrene copolymer blends, poly(meth)acrylate-polyvinylidene difluoride blends, styrene copolymers and polysulfones and mixtures thereof.

Particularly preferred polymers are transparent or at least translucent. Examples include: polypropylene, polyvinylbutyral, nylon-[6], nylon-[6,6], polycarbonate, polycarbonate-polyethylene terephthalate blends, polycarbonate-polybutylene terephthalate blends, polycarbonate-acrylonitrile/styrene/acrylonitrile copolymer blends, polycarbonate-acrylonitrile/butadiene/styrene copolymer blends, polymethyl methacrylate-acrylonitrile/butadiene/styrene copolymer blends (MABS), polyethylene terephthalate, polybutylene terephthalate, polymethyl methacrylate, impact-modified polymethyl methacrylate, polybutyl acrylate, polymethyl methacrylate-polyvinylidene difluoride blends, acrylonitrile/butadiene/styrene copolymers (ABS), styrene/acrylonitrile copolymers (SAN), polyphenylenesulfone and mixtures comprising 2 or more (e.g. 2, 3, 4, 5) of the afore-mentioned polymers.

Suitable polymer preparations for laser welding comprise
A) a thermoplastic matrix polymer suitable for forming the plastics parts,
B) particles of the compound of the formula (I) as defined before,
C) optionally at least one further additive.

Those polymer preparations for laser welding are likewise in accordance with the invention and are suitable for producing fusion-bonded plastic parts with the aid of laser radiation whose wavelength is outside the visible region.

Polymer preparations for laser welding may advantageously be produced by a conventional extrusion or kneading process. The components B), and, if present, C) may be mixed from the outset, in the weight ratio corresponding to the desired end concentration, with the matrix polymer A) (direct compounding), or a distinctly higher concentration of B) and, if present, C) may initially be selected and the concentrate formed (masterbatch) subsequently diluted with further matrix polymer A) in the course of the manufacture of the parts to be fused.

Suitable additives C) are UV stabilizers, antioxidants, processing plasticizers, etc.

In addition, the polymer preparations for laser welding may comprise at least one colorant for establishing a desired hue as additive, especially transparent organic pigments and in particular dyes, for example C.I. Pigment Yellow 138, 139, 147, 183, 185 192 and 196, C.I. Pigment Orange 70, C.I. Pigment Red 149, 178 and 179, 181, 263, C.I. Pigment Violet 19 and 29, C.I. Pigment Blue 15, 15:1, 15:3 and 15:4, C.I. Pigment Green 7 and 36, C.I. Solvent Yellow 14, 21, 93, 130, 133, 145, 163, C.I. Solvent Red 52, 135, 195, 213, 214 and 225, C.I. Solvent Blue 35, 45, 67, 68, 97, 104, 122, 132, C.I. Solvent Violet 13, 46, 49, C.I. Solvent Green 3, 5 and 28, C.I. Solvent Orange 47, 60, 86, 114, and 163, C.I. Solvent Brown 35, 53, and also C.I. Disperse Yellow 54, 87, 201, C.I. Disperse Orange 30, C.I. Disperse Red 60 and C.I. Disperse Violet 57

A further possible additive group is that of additives which likewise modify the visual appearance, the mechanical properties or else the tactile properties, for example matting agents, such as titanium dioxide, chalk, barium sulfate, zinc sulfide, fillers, such as nanoparticulate silicon dioxide, aluminium hydroxide, clay and other sheet silicates, glass fibers and glass spheres.

An especially suitable field of application is the use of the compound of formula (I) in security printing.

The particles of the compound of the general formula (I) has at least one of the following advantageous properties:
good fastness to chemicals, in particular fastness to bleaching with hypochlorite and fastness to solvents (like toluene, acetone or dichloromethane),
good fastness to boiling water,
good fastness to light,
almost colourless (i.e. minimal absorption in the VIS range of the spectrum (from 400 to 700 nm))
good heat stability,
high absorbing properties,
high compatibility with a multiplicity of formulations, in particular printing ink formutations used especially in security printing.

The particles of the compound of general formula (I) can be used inter alia for security printing, invisible and/or IR readable bar codes, the laser-welding of plastics, the curing of surface-coatings using IR radiators, the drying and curing of print, the fixing of toners on paper or plastics, optical filters for plasma display panels, laser marking of paper or plastics, the heating of plastic preforms, 3D printing and for heat shielding applications.

Some examples of three-dimensional (3D) printing may utilize a fusing agent (including an energy absorber) to pattern polymeric build material. The fusing agent is capable of absorbing radiation and converting the absorbed radiation to thermal energy, which in turn coalesces/fuses the polymeric build material that is in contact with the fusing agent.

Accordingly, the present invention is directed to fusing agents, comprising particles of a compound of formula (I), especially a compound of formula (Ia) and (Ib). The composition of the fusing agents is, for example, described in WO2020005200, WO2019245589, WO2019245518, WO2019245517, WO2019245535, WO2019245534, WO2019245516 and US2019382429.

In addition, the present invention is directed to a consumable material for use in an additive manufacturing system, the consumable material comprising:
at least one polymer comprising:
particles of at least one compound of formula (I), especially at least one compound of formula (Ia) and/or (Ib).

In addition, the present invention is directed to a consumable assembly for use in an extrusion-based additive manufacturing system, the consumable assembly comprising:
a container portion;
a consumable filament at least partially retained by the container portion, the consumable filament comprising:
at least one polymer,
particles of at least one compound of formula (I), especially at least one compound of formula (Ia) and/or (Ib).

The consumable filament may have a core comprising the at least one polymer and a coating comprising particles of at least one compound of formula (I) (WO2015130401).

The at least one polymer may be a meltable polymer which is selected from the group consisting of polyurethane, polyester, polyalkylene oxide, plasticized PVC, polyamide, protein, PEEK, PEAK, polypropylene, polyethylene, thermoplastic elastomer, POM, polyacrylate, polycarbonate, polymethylmethacrylate, polystyrene or a combination of at least two of these.

A process for producing an article by means of an additive manufacturing method from the consumable material comprises at least temporarily exposing the consumable material to infrared radiation in the wavelength range between 600 nm and 1700 nm.

The present invention is also directed to an article obtainable by the process.

In a further aspect, the invention provides a printing ink formulation for security printing, comprising the particles of the compound of the formula (I) as defined above.

In a specific embodiment the printing ink formulation, for security printing, comprises
a) the particles of the compound of the formula (I) as defined above,
b) a polymeric binder,
c) a solvent,
d) optionally at least one colorant, and
e) optionally at least one further additive.

More specific the printing ink formulation comprises
a) 0.0001 to 25% by weight of particles of at least one compound of the formula (I) as defined above,
b) 5 to 74% by weight of at least one polymeric binder,
c) 1 to 94.9999% by weight of at least one solvent,
d) 0 to 25% by weight of at least one colorant, and
e) 0 to 25% by weight of at least one further additive,
wherein the sum of components a) to e) adds up to 100%.

Also an aspect of the invention is a process for the manufacture of a security document comprising the steps of printing on a substrate a printing ink formulation as described above.

In another aspect, the invention provides a security document, comprising a substrate and the particles of the compound of the formula (I) as defined above. The security document may be a bank note, a passport, a check, a voucher, an ID- or transaction card, a stamp and a tax label.

Yet in a further aspect, the invention provides a security document, obtainable by a printing process, wherein a printing ink formulation is employed that comprises the particles of the compound of the formula (I) as defined above.

The particles of the IR absorber of formula (I) can also be used in the form of a mixture, comprising at least one compound of the general formula (I) and at least one further IR absorber different from compounds of the general formula (I). Suitable further IR absorbers are in principle all known classes of IR absorbers that are compatible with the compounds of the general formula (I). Preferred further IR absorbers are selected from polymethines, phthalocyanines, quinone-diimmonium salts, aminium salts, rylenes, in organic IR absorbers and mixtures thereof. Further polymethine IR absorbers are preferably selected from cyanines, squaraines, croconaines and mixtures thereof. Further inorganic IR absorbers are preferably selected from indium tin oxide, antimony tin oxide, lanthanum hexaboride, tungsten bronzes, copper salts etc.

The mixture may comprise at least one compound of the general formula (I) and at least one further compound of the general formula (II), such as, for example, a compound of formula

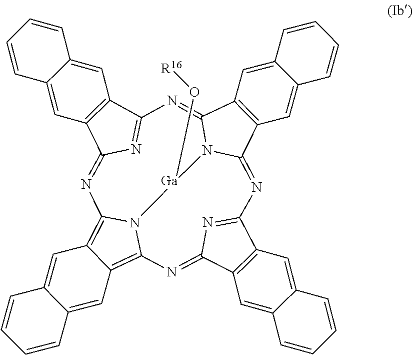

and a compound of formula

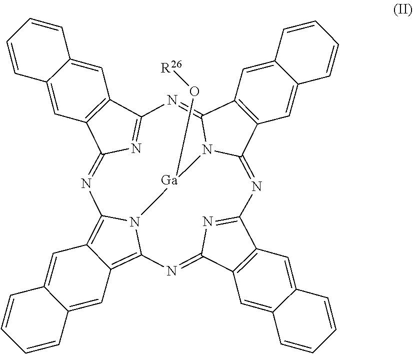

wherein R¹⁶ is a group of formula (CH₂CH₂O)ₙ₁CH₂CH₂R¹⁹, R²⁶ is (CH₂CH₂O)ₙ₄CH₂CH₂R²⁹, wherein R²⁹ is OH, R¹⁹ is OCH₃ and n1 is equal to n4.

The IR absorbers can be generally used in a concentration of from 10 ppm to 25%, preferably 100 ppm to 10%, depending on the chosen application.

The afore-mentioned IR absorbers of the formula (I) and IR absorber mixtures are especially suitable for security printing.

Security printing is the field that deals with the printing of items such as currency, pass ports, tamper-evident labels, stock certificates, postage stamps, identity cards, etc. The main goal of security printing is to prevent forgery, tampering or counterfeiting.

In the field of automated banknote processing, IR-absorption plays an important role. Most of the actually circulating currency carries not only visibly coloured printings, but also specific features which are only detectable in the infrared part of the spectrum. Generally, these IR-features are implemented for use by automatic currency processing equipment, in banking and vending applications (automatic teller machines, automatic vending machines, etc.), in order to recognize a determined currency bill and to verify its authenticity, in particular to discriminate it from replicas made by colour copiers.

All security documents are required to have good stability and durability. In the case of bank notes, these requirements are extreme, as bank notes are subjected to toughest use conditions by the public—they are subjected to material stress by folding, crumpling etc., subjected to abrasion, exposed to weather, exposed to bodily fluids such as perspiration, laundered, dry-cleaned, ironed etc.—and, after having been subjected to this, are expected to be as legible as when they started. Furthermore, it is essential that the documents nevertheless should have a reasonable life time, ideally of some years, despite suffering the afore-mentioned conditions. During this time, the documents, and thus the inks on them (including invisible security markings), should be resistant to fading or colour change. Hence, any ink used in a security printing process should, when cured, be robust, water-resistant, resistant to various chemicals and flexible. Moreover, as certain states are moving away from the use of paper as the substrate for bank notes, the employed printing ink formulations should be useable on plastics as well as paper.

In one aspect the present invention is directed to the use of particles of the compound of the formula (I) for security printing, especially security printing of bank notes. The particles of the compound of formula (I) may exhibit improved resistance against chemicals and solvents as well as high light stability, particularly against UV light.

Advantageously, the particles of the compound of the formula (I) may be used in a printing ink formulation for security printing to improve the fastness properties of the obtained print, in particular to improve the fastness to UV-light, chemicals, solvents and/or boiling water, without sacrificing the desired IR absorption properties.

In security printing, the particles of the compound of formula (I) is added to a printing ink formulation. Suitable printing inks are water-based, oil-based or solvent-based printing inks, based on pigment or dye, for inkjet printing, flexographic printing, screen printing, intaglio printing, offset printing, laser printing or letterpress printing and for use in electrophotography. Printing inks for these printing processes usually comprise sol vents, binders, and also various additives, such as plasticizers, antistatic agents or waxes. Printing inks for offset printing and letterpress printing are usually formulated as high-viscosity paste printing inks, whereas printing inks for flexographic printing and intaglio printing are usually formulated as liquid printing inks with comparatively low viscosity.

In the context of the present invention, the expression “printing ink” also encompasses formulations that in addition to particles of at least one IR absorber of the general formula (I) comprise a colorant. The expression “printing ink” also encompasses printing lacquers that comprise no colorant.

Suitable components of printing inks are conventional and are well known to those skilled in the art. Examples of such components are described in “Printing Ink Manual”, fourth edition, Leach R. H. et al. (eds.), Van Nostrand Reinhold, Wokingham, (1988). Details of printing inks and their formulation are also disclosed in “Printing Inks”-Ullmann's Encyclopedia of Industrial Chemistry, Sixth Edition, 1999 Electronic Release. A formulation of an IR-absorbing intaglio ink formulation is described in US 20080241492 A1. The disclosure of the afore-mentioned documents is incorporated herein by reference.

The printing ink formulation according to the invention contains in general from 0.0001 to 25% by weight, preferably from 0.001 to 15% by weight, in particular from 0.1 to 10% by weight, based on the total weight of the printing ink formulation, of the particles of the compound of formula (I), component a).

The particles of the compound of formula (I) are present in the printing ink formulation in dissolved form or in solid form (in a finely divided state). Due to their pigment proper ties to solid form is preferred.

The printing ink formulation according to the invention contains in general from 5 to 74% by weight, preferably from 10 to 60% by weight, more preferably from 10 to 30% by weight, based on the total weight of the printing ink formulation, of component b).

Suitable polymeric binders b) for the printing ink formulation according to the invention are for example selected from natural resins, phenol resin, phenol-modified resins, alkyd resins, polystyrene homo- and copolymers, terpene resins, silicone resins, polyurethane resins, urea-formaldehyde resins, melamine resins, polyamide resins, polyacrylates, polymethacrylates, chlorinated rubber, vinyl ester resins, acrylic resins, epoxy resins, nitrocellulose, hydrocarbon resins, cellulose acetate, and mixtures thereof.

The printing ink formulation according to the invention can also comprise components that form a polymeric binder by a curing process. Thus, the printing ink formulation according to the invention can also be formulated to be energy-curable, e.g. able to be cured by UV light or EB (electron beam) radiation. In this embodiment, the binder comprises one or more curable monomers and/oligomers. Corresponding formulations are known in the art and can be found in standard textbooks such as the series “Chemistry & Technology of UV & EB Formulation for Coatings, Inks & Paints”, published in 7 volumes in 1997-1998 by John Wiley & Sons in association with SITA Technology Limited.

Suitable monomers and oligomers (also referred to as prepolymers) include epoxy acrylates, acrylated oils, urethane acrylates, polyester acrylates, silicone acrylates, acrylated amines, and acrylic saturated resins. Further details and examples are given in “Chemistry & Technology of UV & EB Formulation for Coatings, Inks & Paints”, Volume II: Prepolymers & Reactive Diluents, edited by G Webster.

If a curable polymeric binder is employed, it may contain reactive diluents, i.e. monomers which act as a solvent and which upon curing are incorporated into the polymeric binder. Reactive monomers are typically chosen from acrylates or methacrylates, and can be monofunctional or multifunctional. Examples of multifunctional monomers include polyester acrylates or methacrylates, polyol acrylates or methacrylates, and polyether acrylates or methacrylates.

In the case of printing ink formulations to be cured by UV radiation, it is usually necessary to include at least one photoinitiator to initiate the curing reaction of the monomers upon exposure to UV radiation. Examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerisation”, 2nd edition, by J. V. Crivello & K. Dietliker, edited by G. Bradley and published in 1998 by John Wiley & Sons in association with SITA Technology Limited. It may also be advantageous to include a sensitizer in conjunction with the photoinitiator in order to achieve efficient curing.

The printing ink formulation according to the invention contains in general from 1 to 94.9999% by weight, preferably from 5 to 90% by weight, in particular from 10 to 85% by weight, based on the total weight of the printing ink formulation, of a solvent c).

Suitable solvents are selected from water, organic solvents and mixtures thereof. For the purpose of the invention, reactive monomers which also act as solvents are regarded as part of the afore-mentioned binder component b).

Examples of solvents comprise water; alcohols, e.g. ethanol, 1-propanol, 2-propanol, ethylene glycol, propylene glycol, diethylene glycol and ethoxy propanol; esters, e.g. ethyl acetate, isopropyl acetate, n-propyl acetate and n-butyl acetate; hydrocarbons, e.g. toluene, xylene, mineral oils and vegetable oils, and mixtures thereof.

The printing ink formulation according to the invention may contain an additional colorant d). Preferably, the printing ink formulation contains from 0 to 25% by weight, more preferably from 0.1 to 20% by weight, in particular from 1 to 15% by weight, based on the total weight of the printing ink formulation, of a colorant d).

Suitable colorants d) are selected conventional dyes and in particular conventional pigments. The term “pigment” is used in the context of this invention comprehensively to identify all pigments and fillers, examples being colour pigments, white pigments, and inorganic fillers. These include inorganic white pigments, such as titanium dioxide, preferably in the rutile form, barium sulfate, zinc oxide, zinc sulfide, basic lead carbonate, antimony trioxide, lithopones (zinc sulfide+barium sulfate), or coloured pigments, examples being iron oxides, carbon black, graphite, zinc yellow, zinc green, ultramarine, manganese black, antimony black, manganese violet, Paris blue or Schweinfurt green. Besides the inorganic pigments the printing ink formulation of the invention may also comprise organic colour pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone, and metal complex pigments. Also suitable are synthetic white pigments with air inclusions to increase the light scattering, such as the Rhopaque® dispersions. Suitable fillers are, for example, aluminosilicates, such as feldspars, silicates, such as kaolin, talc, mica, magnesite, alkaline earth metal carbonates, such as calcium carbonate, in the form for example of calcite or chalk, magnesium carbonate, dolomite, alkaline earth metal sulfates, such as calcium sulfate, silicon dioxide, etc.

The printing ink formulation according to the invention may contain at least one additive e). Preferably, the printing ink formulation contains from 0 to 25% by weight, more preferably from 0.1 to 20% by weight, in particular from 1 to 15% by weight, based on the total weight of the printing ink formulation, of at least one component e).

Suitable additives (component e)) are selected from plasticizers, waxes, siccatives, antistatic agents, chelators, antioxidants, stabilizers, adhesion promoters, surfactants, flow control agents, defoamers, biocides, thickeners, etc. and combinations thereof. These additives serve in particular for fine adjustment of the application-related properties of the printing ink, examples being adhesion, abrasion resistance, drying rate, or slip.

The printing ink formulations according to the invention are advantageously prepared in a conventional manner, for example by mixing the individual components. As mentioned earlier, the particles of the compound of formula (I) is present in the printing ink formulations in a dissolved or finely divided solid form. Additional colorants may be employed in the printing ink formulation of the invention or in a separate ink formulation. When additional colorants are to be employed in a separate formulation, the time of application of the printing ink formulation according to the invention is usually immaterial. The printing ink formulation according to the invention can for example be applied first and then be overprinted with conventional printing inks. But it is also possible to re verse this sequence or, alternatively, to apply the printing ink formulation according to the invention in a mixture with conventional printing inks. In every case the prints are readable with suitable light sources.

Primers can be applied prior to the printing ink formulation according to the invention. By way of example, the primers are applied in order to improve adhesion to the substrate. It is also possible to apply additional printing lacquers, e.g. in the form of a covering to protect the printed image. Additional printing lacquers may also be applied to serve aesthetic purposes, or serve to control application-related properties. By way of example, suitably formulated additional printing lacquers can be used to influence the roughness of the surface of the substrate, the electrical properties, or the water-vapour-condensation properties. Printing lacquers are usually applied in-line by means of a lacquering system on the printing machine employed for printing the printing ink formulation according to the invention.

The printing ink formulations according to the invention are also suitable for use in multilayer materials. Multilayer materials are e.g. composed of two or more plastics foils, such as polyolefin foils, metal foils, or metallised plastics foils, which are bonded to one another, by way of example, via lamination or with the aid of suitable laminating adhesives. These composites may also comprise other functional layers, such as odour-barrier layers or water-vapour barriers.

The printing ink formulations may additionally comprise one or more UV absorbers. UV absorbers are well known in the plastics, coatings and cosmetic industry. Examples for suitable UV absorbers are subsequently given. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

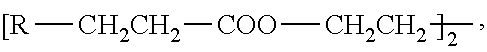

where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]benzotriazole. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl □-carbomethoxy-p-methoxycinnamate, N-(β-carbomethoxy-β-cyanovinyl)-2-methylindoline, neopentyl tetra(α-cyano-β,β-diphenylacrylate.

Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and pmethoxy-disubstituted oxanilides and mixtures of o- and p-ethoxy-disubstituted oxanilides.

2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

### Example 1

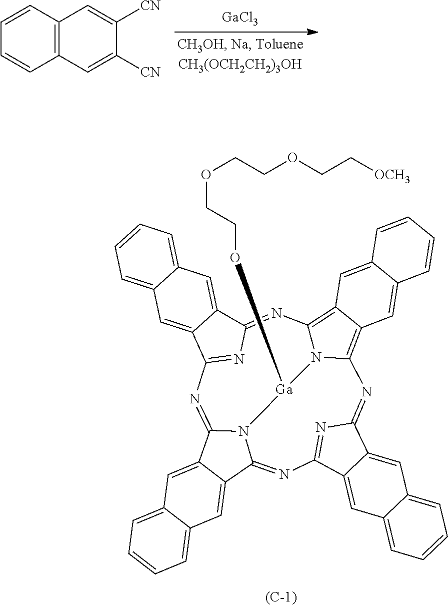

### a) 1-[2-[2-(2-Methoxyethoxy)ethoxy]ethoxy] Ga-naphthalocyanine (cpd. CC-1 (crude))

6.2 g sodium are dissolved in 200 g methanol and slowly added to a solution of 15.0 g gallium chloride in 250 g toluene at room temperature. To the resulting suspension is added a mixture of 62 g naphthalene-2,3-dicarbonitrile, 240 g triethyleneglycol-monomethylether and 240 g toluene. Toluene and the excess of methanol are distilled off under reduced pressure and the reaction mixture is stirred at 170° C. for 5 hours.

The suspension is cooled to 80° C., 250 g DMF is added and then further cooled to room temperature. The green solid is collected by filtration, successively washed with DMF, acetone and water and then dried (yield: 41 g; dark green powder). The obtained particles of compound (CC-1) have a number average particle size of 81 nm with standard deviation being 102 nm, D₉₀=152.5 nm. The particle size is measured with transmission electron microscopy (TEM).

b) 50 g cpd. (cpd. 1c (kneaded)), 175 g sodium chloride and 60 g HO(CH₂CH₂O)₃CH₃ are added subsequently at room temperature. Kneading is carried out for 6 hours and at room temperature and then the mixture is slowly heated up to 90° C. After continuing for 6 hours, the mixture is cooled down, 1 L of deionized water is added and mixing is continued for one more hour. Then the mixture is filtrated, washed with 6 L of deionized water, DMF, acetone and again with water and dried in an oven (yield: 59 g; dark green powder). The obtained particles of compound (1c) have a number average particle size of 42.7 nm with standard deviation being 20.1 nm, D₉₀=67.4 nm. The particle size is measured with transmission electron microscopy (TEM).

TEM analysis of dispersions was performed on “Libra 120”, an instrument from ZEISS in bright field mode at an electron beam acceleration voltage of 120 kV. The TEM was used with an energy filter for better contrast. At least 2 representative images with scale in the same magnification were recorded in order to characterize the dominate particle morphology for each sample. The minimal feret diameter of the particles was determined with the software “ImageJ”, which is based on the measurement of at least 4800 randomly selected particles.

### Offset Printing Procedure

An offset ink is prepared by mixing the following components by means of an automatic pigment muller:

| | |
|---|---|
| Offset varnish | 2000 mg |
| IR absorber, cpd. 1c (kneaded)), or cpd. 1c (crude) | 40 mg |
| prepared as described above | |
| Siccative | 20 mg |

Immediately afterwards the freshly prepared offset ink is printed onto cotton paper with a printability tester (IGT Orange Proofer). The remission is measured with the help of a spectrophotometer and is shown for cpd. 1c (kneaded) as well as cpd. 1c (crude) in the table below and in FIG. 2.

| lambda | Cpd. CC-1 (crude, comparative) | Cpd. 1c (kneaded, inventive) |
|---|---|---|
| [nm] | Remission [%] | Remission [%] |
| 550 | 89.0 | 87.1 |
| 600 | 88.6 | 85.3 |
| 650 | 79.5 | 64.0 |
| 700 | 68.4 | 38.8 |
| 750 | 60.3 | 28.4 |
| 800 | 60.8 | 31.7 |
| 850 | 64.9 | 38.9 |
| 900 | 69.6 | 50.7 |
| 1000 | 88.3 | 93.9 |
| 1050 | 94.7 | 97.2 |
| 1100 | 96.8 | 97.7 |

It is evident from the above table and FIG. 2 that kneaded cpd. 1c has a lower remission (a higher IR absorbance) in comparison to the cpd. CC-1 obtained according to Example 1a.

1.-15. (canceled)

16. Particles of a compound of formula 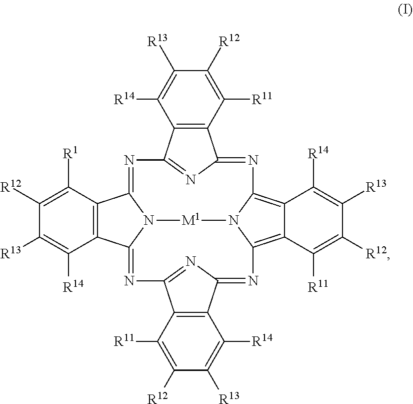
wherein
M¹ is Al(R¹⁵), or Ga(R¹⁵),
R¹⁵ is OH, or OR¹⁶;
R¹¹ and R¹⁴ are independently of each other H, F, OR^{17″}, SR^{17″}, or NR¹⁷R^{17′},
R¹² and R¹³ are independently of each other H, F, OR^{17″}, SR^{17″}, NHR¹⁷, or NR¹⁷R^{17′}, or R¹² and R¹³ together with the C atoms to which they are bonded form a 6-membered aromatic ring, which may optionally be substituted,
R¹⁶ is a group of formula 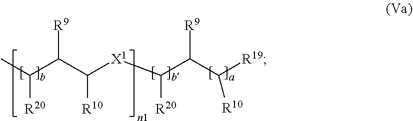
X¹ is O, S or NH,
R⁹ and R¹⁰ are the same or different and are each independently hydrogen, or a methyl group;
R¹⁷, R^{17′} and R^{17″} are independently of each other a C₁-C₁₂alkyl group, (CH₂CH₂O)ₙR¹⁸, or phenyl; or
R¹⁷ and R^{17′} together with the C atoms to which they are bonded form together a 5- or 6-membered saturated N-heterocyclic ring, which is optionally substituted by 1 or 2 methyl groups;
R¹⁸ is a C₁-C₁₂alkyl group;
R¹⁹ is a OC₁-C₁₂alkyl group, especially a OC₁-C₄alkyl group;
R²⁰ is H, or a C₁-C₄alkyl group;
a is 0, or 1; b is 0, or 1; b′ is 0, or 1;
n is 0, 1, 2, 3 or 4; and
n1 is 0, or a value from 1 to 10; n2 is 0, or a value from 1 to 10; n3 is a value from 1 to 10; wherein the particles have a number average particle size in the range of from 10 nm to 80 nm, with standard deviation being less than 40 nm.

17. The particles according to claim 16, wherein the compound of formula (I) is a compound of formula 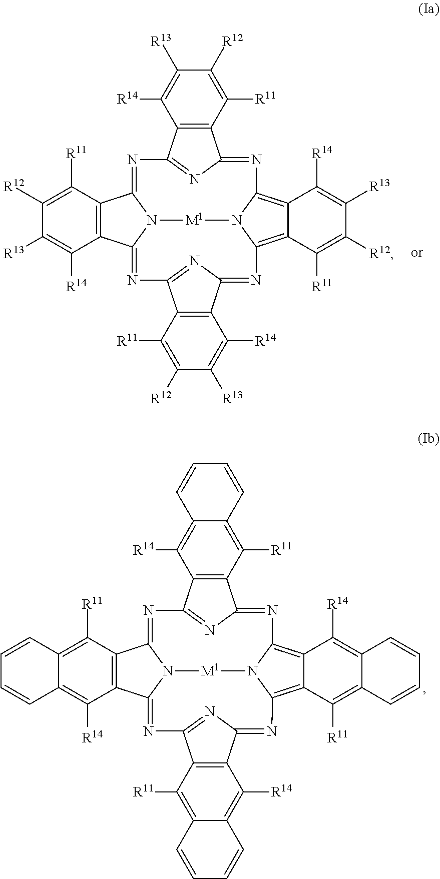
wherein
R¹² and R¹³ are independently of each other H, F, OR^{17″}, SR^{17″}, NHR¹⁷, or NR¹⁷R^{17′}, and M¹, R¹¹, R¹⁴, R¹⁷, R^{17′} and R^{17″}.

18. The particles according to claim 17, wherein in the compound of formula (Ib) R¹¹ and R¹⁴ are H.

19. The particles according to claim 17, wherein in the compound of formula (Ia) R¹¹, R¹², R¹³ and R¹⁴ are H.

20. The particles according to claim 16, wherein the compound of formula (I) is a compound

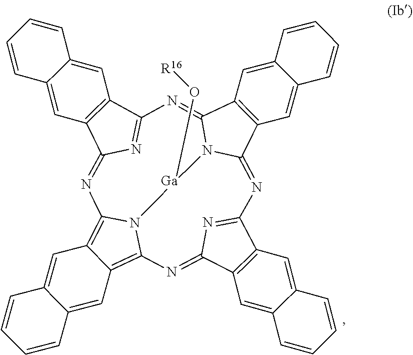

| Cpd. | R¹⁶ |
|---|---|
| 1a | CH₂CH₂OCH₃ |
| 1b | (CH₂CH₂O)₂CH₃ |
| 1c | (CH₂CH₂O)₃CH₃ |
| 1d | CH₂CH(CH₃)OCH₃ |
| 1e | (CH₂CH(CH₃)O)₂CH₃ |
| 1f | (CH₂CH(CH₃)O)₃CH₃ |
| 1g | CH₂CH₂NHCH₂CH₂OCH₃ |
| 1h | CH₂CH(OH)CH₂OCH₃ |
| 1i | (CH₂CH(CH₃)O)ₙ₁CH₃ (n1 approx. 7) |
| 1j | CH₂CH₂CH₂OCH₃ |

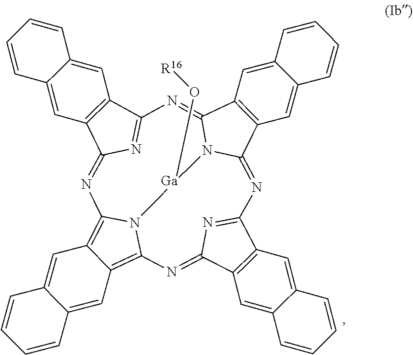
| Cpd. | R¹⁶ |
|---|---|
| 2a | CH₂CH₂OCH₃ |
| 2b | (CH₂CH₂O)₂CH₃ |
| 2c | (CH₂CH₂O)₃CH₃ |
| 2d | CH₂CH(CH₃)OCH₃ |
| 2e | (CH₂CH(CH₃)O)₂CH₃ |
| 2f | (CH₂CH(CH₃)O)₃CH₃ |
| 2g | CH₂CH₂NHCH₂CH₂OCH₃ |
| 2h | CH₂CH(OH)CH₂OCH₃ |
| 2i | (CH₂CH(CH₃)O)ₙ₁CH₃ (n1 approx. 7) |
| 2j | CH₂CH₂CH₂OCH₃ |

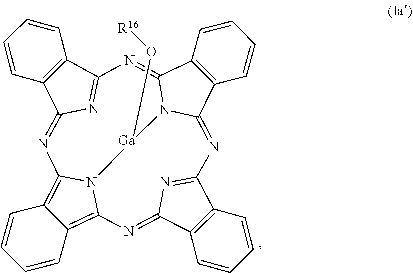
| Cpd. | R¹⁶ |
|---|---|
| 3a | CH₂CH₂OCH₃ |
| 3b | (CH₂CH₂O)₂CH₃ |
| 3c | (CH₂CH₂O)₃CH₃ |
| 3d | CH₂CH(CH₃)OCH₃ |
| 3e | (CH₂CH(CH₃)O)₂CH₃ |
| 3f | (CH₂CH(CH₃)O)₃CH₃ |
| 3g | CH₂CH₂NHCH₂CH₂OCH₃ |
| 3h | CH₂CH(OH)CH₂OCH₃ |
| 3i | (CH₂CH(CH₃)O)ₙ₁CH₃ (n1 approx. 7) |
| 3j | CH₂CH₂CH₂OCH₃ |

or

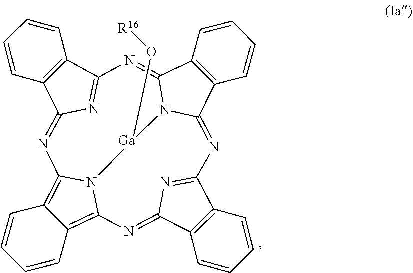

| Cpd. | R¹⁶ |
|---|---|
| 4a | CH₂CH₂OCH₃ |
| 4b | (CH₂CH₂O)₂CH₃ |
| 4c | (CH₂CH₂O)₃CH₃ |
| 4d | CH₂CH(CH₃)OCH₃ |
| 4e | (CH₂CH(CH₃)O)₂CH₃ |
| 4f | (CH₂CH(CH₃)O)₃CH₃ |
| 4g | CH₂CH₂NHCH₂CH₂OCH₃ |
| 4h | CH₂CH(OH)CH₂OCH₃ |
| 4i | (CH₂CH(CH₃)O)ₙ₁CH₃ (n1 approx. 7) |
| 4j | CH₂CH₂CH₂OCH₃ |

21. A method comprising utilizing the particles according to claim 16 as IR absorber for optical filter applications, for plasma display panels, for laser marking of paper or plastics, for laser welding of plastics, for 3D printing, for the curing of surface-coatings using IR radiators, for the drying and curing of print, for the fixing of toners on paper or plastics, for heat shielding applications, for invisible and/or IR readable bar codes, or as IR absorber in security printing.

22. A printing ink formulation, comprising the particles according to claim 16.

23. The printing ink formulation according to claim 22, further comprising
a) a polymeric binder,
b) a solvent,
c) optionally at least one colorant, and
d) optionally at least one further additive.

24. The printing ink formulation according to claim 23, comprising
a) 0.0001 to 25% by weight of the particles,
b) 5 to 74% by weight of at least one polymeric binder,
c) 1 to 94.9999% by weight of at least one solvent,
d) 0 to 25% by weight of at least one colorant, and
e) 0 to 25% by weight of at least one further additive,
wherein the sum of components a) to e) adds up to 100%.

25. A process for the manufacture of a security document comprising the steps printing on a substrate a printing ink formulation according to claim 22.

26. A security document, comprising a substrate and at least one compound according to claim 16.

27. The security document according to claim 26, which is selected from a bank note, a passport, a check, a voucher, an ID- or transaction card, a stamp and a tax label.

28. A process for the production of the particles according to claim 16, comprising
a) providing a mixture of a compound of formula 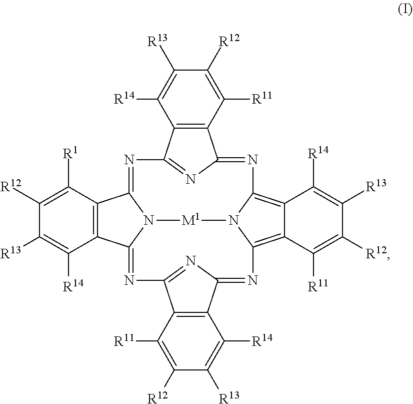
a solvent and an inorganic salt, wherein M¹, R¹¹, R¹², R¹³, R¹⁴ and R¹⁶ are defined in claim 16; and
b) kneading the mixture at a temperature of from 20 to 150° C. for a sufficient period of time.

29. The process according to claim 28, wherein the inorganic salt is selected from sodium chloride and sodium sulfate.

30. The process according to claim 28, wherein the solvent is a compound of formula HOR¹⁶ (III).
